(19) United States
(12) Patent Application Publication
(10) Pub. No.: US 2017/0229714 A1
(43) Pub. Date: Aug. 10, 2017

(54) EMBOSSED METAL SEAL DESIGN WITH IMPROVED CONTACT PRESSURE UNIFORMITY UNDER CONDITIONS OF MISALIGNMENT

(71) Applicant: GM GLOBAL TECHNOLOGY OPERATIONS LLC, DETROIT, MI (US)

(72) Inventor: MATTHEW J. BEUTEL, WEBSTER, NY (US)

(21) Appl. No.: 15/016,121

(22) Filed: Feb. 4, 2016

(51) Int. Cl. H01M 8/0247

(52) U.S. Cl. CPC H01M 8/0247

(57) ABSTRACT

Bipolar plates for a fuel cell stack that include opposing stamped metal plate halves having specialized embossed features so that when the stack is assembled, the embossed features of opposing plate halves are positioned relative to each other so that a centerline of opposing seal paths are offset to create offsets between more rigid sections and less rigid sections in the bipolar plate that allows for more uniform sealing along bead seals between the plate halves under the compressive assembly force.

### BACKGROUND OF THE INVENTION

Field of the Invention

This invention relates generally to bipolar plates for a fuel cell stack that include embossed features for sealing and, more particularly, to bipolar plates for a fuel cell stack that include embossed features, where bipolar plate halves are assembled so that the embossed features of opposing plate halves are offset relative each other to reduce the seal force and/or pressure variation around a seal perimeter.

Discussion of the Related Art

A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free hydrogen protons and electrons. The hydrogen protons pass through the electrolyte to the cathode. The electrons from the anode cannot pass through the electrolyte, and thus are directed through a load to perform work before being sent to the cathode. Proton exchange membrane fuel cells (PEMFC) are a popular fuel cell type for vehicles, and generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer, where the catalytic mixture is deposited on opposing sides of the membrane. The combination of the anode catalytic mixture, the cathode catalytic mixture and the membrane define a membrane electrode assembly (MEA). The membranes block the transport of gases between the anode side and the cathode side of the fuel cell stack while allowing the transport of protons to complete the anodic and cathodic reactions on their respective electrodes.

Several fuel cells are typically combined in a fuel cell stack to generate the desired power. A fuel cell stack typically includes a series of flow field or bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

The fuel cell stack includes an active region in which the MEAs are located, which is the area in the stack where the electro-chemical reaction occurs. The reactant gases are fed to the channels in the active region from an inlet header or headers through a non-active feeder region that includes a sub-gasket between the cathode and anode flow channels instead of the MEA. The bipolar plates are typically assembled and welded together so that the reactant gases and the cooling fluid can be separated and coupled to appropriate manifold headers. The bipolar plates are generally configured so that the cathode reactant gas flow channels and the anode reactant gas flow channels are substantially the same size in both the active and non-active regions.

Various techniques are known in the art for fabricating the bipolar plates. In one design, stamped metal plate halves are assembled together so that anode flow channels are provided at one side of one of the plate halves, cathode flow channels are provided at an opposite side of the other plate half and cooling fluid flow channels are provided between the plate halves. The bipolar plates are stacked on top of each other and then compressed between end structures so as to seal the various channels therein.

The stamped shape of the plate halves define embossed features in the plate, such as grooves that ultimately define the reactant gas or cooling fluid flow channels and seals. The embossed features for channels can be in-phase and aligned or out of phase and misaligned. The anode to cathode channel alignment through an MEA can be substantially different, i.e., aligned or orthogonal. When an embossed feature is used for sealing, the embossed feature path essential follows the same path in the anode and the cathode plate halves. When opposing plate halves for a bipolar plate are stacked during the assembly process those areas where the plate halves contact each other can define bead seals, where the contact area is rigid, and those areas that are spaced apart from each other are deformable and resilient. The compressive force applied to the stack of bipolar plates during assembly causes the plate halves to be sealed together at the bead seals. Typically, a thin elastomer is placed on the plate halves at the bead seal locations to increase the sealing effect.

During the assembly process of the fuel cell stack the embossed features in the halve plates are aligned with each other as best as possible. However, because of inefficiencies in the assembly process and the number of plate halves required for a typical fuel cell stack, the embossed features in the plate halves are not perfectly aligned. This misalignment between the plate halves results in undesirable pressure variations on the plate halves that affects the plate sealing. Further, various locations in the feeder region and a transition region between the feeder region and the active region are curved to allow the reactant gases to be directed to the particular manifold. A straight embossed feature path will be less stiff that a curved embossed feature path. Header shapes and active area footprints require that the seal path embossed feature have turns to seal around the shapes, which will have a stiffer sealing-deflection response than a straight seal path. Plate halves will need to contact each other with a UEA subgasket separating the contact in the sealing areas. The corner or bend stiffness of a seal embossment feature as it encircles a header or active area shape will have sealing variations.

### SUMMARY OF THE INVENTION

The present invention discloses and describes bipolar plates for a fuel cell stack that include opposing stamped metal plate halves having specialized embossed features so that when the stack is assembled, the embossed features of opposing plate halves are positioned relative to each other so that a centerline of opposing seal paths are offset to create offsets between more rigid sections and less rigid sections in the bipolar plate that allows for more uniform sealing along bead seals between the plate halves under the compressive assembly force.

Additional features of the present invention will become apparent from the following description and appended claims, taken in conjunction with the accompanying drawings.

### BRIEF DESCRIPTION OF THE DRAWINGS

FIG. 1 is a partial cross-sectional view of a header seal embossment of a known fuel cell stack showing two non-nested stamped bipolar plates;

FIG. 2 is a broken-away top view of a known bipolar plate half showing header apertures;

FIG. 3 is a partial cross-sectional view of an inactive feeder region of a fuel cell stack showing two non-nested stamped bipolar plate halves, where embossed features in opposing plate halves are offset relative to each other; and

FIG. 4 is a partial cross-sectional view of the fuel cell stack shown in FIG. 3 after the stack has been compressed during assembly.

### DETAILED DESCRIPTION OF THE EMBODIMENTS

The following discussion of the embodiments of the invention directed to bipolar plates for a fuel cell stack that include opposing stamped metal plate halves having specialized misaligned embossed features is merely exemplary in nature, and is in no way intended to limit the invention or its applications or uses.

FIG. 1 is a partial cross-sectional view through a portion of an inactive feeder region in a known fuel cell stack 10. This portion of the fuel cell stack 10 shows two bipolar plates 12 and 14 with a unitized electrode assembly (UEA) sub-gasket 16 positioned therebetween. The bipolar plate 12 includes a cathode plate half 18 and an anode plate half 20, and the bipolar plate 14 includes a cathode plate half 22 and an anode plate half 24. Each of the plate halves 18, 20, 22 and 24 are stamped metal plates with the configuration as shown and include embossed features 26 to define seals, lands, grooves, etc. for the particular fuel cell stack design. When the plate halves 18, 20, 22 and 24 are coupled to provide the bipolar plates 12 and 14, the features 26 define cooling fluid flow channels 30 between the plate halves 18 and 20 and the plate halves 22 and 24, anode reactant gas flow channels 34, and cathode reactant gas flow channels 36. It is apparent that the fuel cell stack 10 would be repetitive for some distance left and right and up and down to define the many reactant gas flow channels 34 and 36 and the cooling fluid flow channels 30 in the complete fuel cell stack 10.

The stack 10 is subject to a compressive force during stack assembly, as generally represented by compressive force arrows 38. The contact areas between the plate halves 18 and 20 and the plate halves 22 and 24 define bead seals 40 that seal the various channels 30, 34 and 36 in the stack 10. The configuration of the embossed features 26 provides more rigid areas 42 that are less likely to deform under the compressive force 38 and less rigid areas 44 that are more likely to deform under the compressive force 38.

The portion of the bipolar plates 12 and 14 shown in FIG. 1 is in the inactive feeder region and as such includes the sub-gasket 16. The sub-gasket 16 is a separation layer between the channels 34 and 36 in this region and could be any suitable material, such as Kapton, polyethylene naphthalate, or some other plastic. It is noted that the configuration of the plate halves 18, 20, 22 and 24 discussed herein will be equally applicable for the active region of the fuel cell stack 10, where the sub-gasket 16 is replaced with an MEA and a gas diffusion media layer in a manner well understood by those skilled in the art. The plate halves 18, 20, 22 and 24 are continuous across the entire fuel cell stack 10 including all of the active region, inactive regions and manifolds.

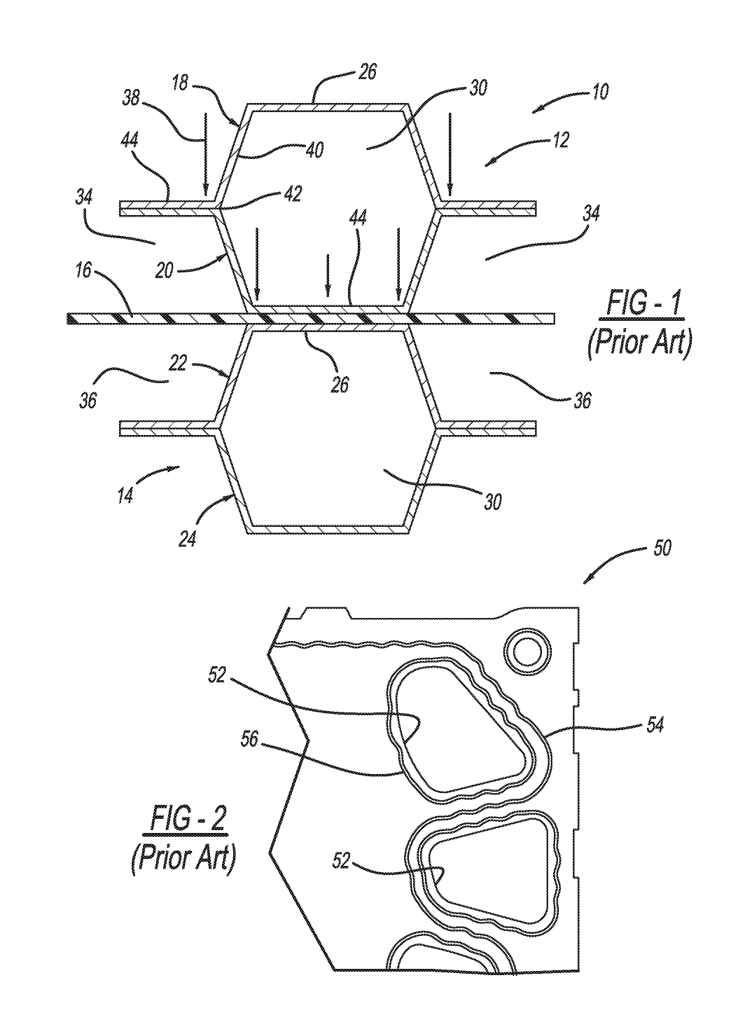

As mentioned above, typically, even though perfect alignment of the plate halves 18, 20, 22 and 24 is desired, there is some misalignment between the plate halves 18, 20, 22 and 24 such that the seal integrity of the bead seals 40 is decreased especially in those regions where the channels, such as the cooling fluid flow channels 30, are curved. FIG. 2 is a broken-away top view of a corner of a known stamped bipolar plate half 50 illustrating areas where curvature in the plate features creates areas where alignment of the plate halves 18, 20, 22 and 24 may reduce the ability of contact pressure variations along the bead seal 40. Particularly, the plate half 50 includes a number of openings 52 that provide, for example, collection areas of a cooling fluid flowing in the cooling fluid channels 30 to be sent to an outlet manifold header (not shown). Bead seals 54 and 56 are shown in the plate half 50 as areas where embossed features in the plate 50 contact embossed features in other plates to form the seals 54 and 56. As is apparent, the bead seals 54 and 56 have a wavy configuration that is employed to reduce variations in seal pressure along the seal path.

As will be discussed in detail below, the present invention proposes configuring the embossed features in bipolar plate halves so that when the bipolar plate halves are aligned with each other during the stack assembly process, the embossed features are offset relative to each other so that the more rigid areas in one plate half are somewhat aligned with the less rigid more elastic areas in an adjacent plate half to provide a seal pressure along the seal path and across the seal path to have less variation. This offset between the embossed features of the plate halves provides less pressure variation along the curved areas of the embossed features, such as those discussed above with reference to FIG. 2. The offset reduces or eliminates the expected variations in contact pressure across the width of the bead to bead contact and also contact pressure variations as the bead path transitions from straight to curved sections along the length of the seal path.

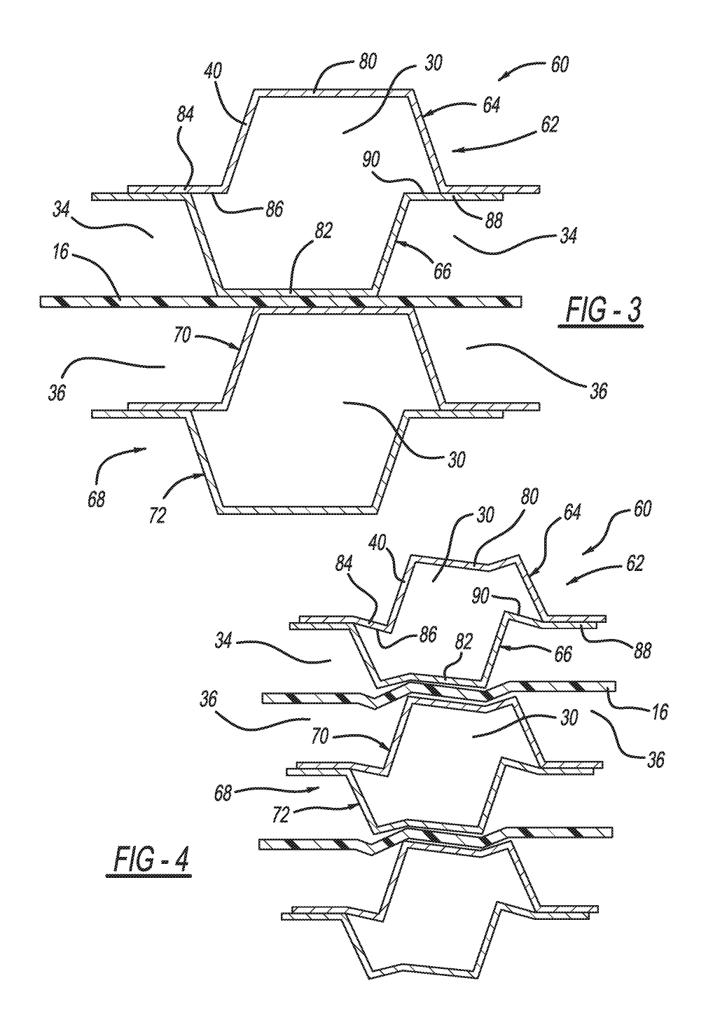

FIG. 3 is a partial cross-sectional view of a fuel cell stack 60 similar to fuel cell stack 10, where like elements are shown by the same reference number, and where the embossed features in the plate halves are configured so that they do not exactly align between the plate halves and are offset relative to each other. Particularly, the fuel cell stack 60 includes a bipolar plate 62 having a cathode plate half 64 and an anode plate half 66, and includes a bipolar plate 68 having a cathode plate half 70 and an anode plate half 72. The plate half 64 includes an embossed feature 80 and the plate half 66 includes an embossed feature 82. The embossed features 80 and 82 are intentionally configured in the plate halves 64 and 66, respectively, so that they are offset relative to each other in the stack 60, as shown, where a land 84 in the plate half 64 extends partially across the embossed feature 82 and defines an offset 86, and a land 88 in the plate half 66 extends partially across the embossed features 80 and defines an offset 90. In this manner, the more rigid area defined by the embossed feature in one plate half extends partially into the less rigid area defined by the embossed feature in an opposing plate half so that less deformation in the plate halves occurs. The seal path between the opposing plate halves 64 and 66 are aligned, but the centerline of the seal paths are offset. Thus, there is a more uniform seal pressure along the bead seals 40 creating a higher integrity seal, especially at those locations where the bead seals 40 travel around a curved feature. Further, reductions in sensitivity to alignment tolerances across the seal bead compressive pressure gains and losses are better equalized.

FIG. 4 is a partial cross-sectional view of the fuel cell stack 60 after the stack 60 has been subjected to the compressive sealing forces 38 discussed above. Because of the offsets 86 and 90 relative to the rigid sealing areas and the embossed features 80 and 82 discussed above, the deformation caused by the compressive forces 38 is more consistent across the lands 84 and 88 and the embossed features 80 and 82 to provide a more consistent seal.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell stack comprising at least one bipolar plate including a first plate half and a second plate half each including embossed features, wherein the first and second plate halves are positioned in contact with each other so that contact areas in the first plate half are positioned relative to contact areas in the second plate half in a manner so that the embossed features are offset relative to each other so that a portion of the contact areas in the first plate half extends across the embossed features in the second plate half and a portion of the contact areas in the second plate half extends across the embossed features in the first plate half.

2. The fuel cell stack according to claim 1 wherein a seal path between the first and second plate halves are aligned, but a centerline of the seal path is offset.

3. The fuel cell stack according to claim 1 wherein the first and second plate halves are stamped metal plates.

4. The fuel cell stack according to claim 1 wherein the embossed features in the first and second plate halves define seals in the bipolar plate.

5. The fuel cell stack according to claim 1 wherein the bipolar plate extends across an active region and an inactive region in the fuel cell stack.

6. The fuel cell stack according to claim 1 wherein the embossed features are curved to accommodate an opening in the first and second plate halves.

7. The fuel cell stack according to claim 1 wherein the first and second plate halves are subjected to a compressive force to provide a bead seal at the contact areas.

8. The fuel cell stack according to claim 1 wherein the at least one bipolar plate is a plurality of bipolar plates each including a first plate half and a second plate half having embossed features.

9. A fuel cell stack comprising a plurality of bipolar plates each including opposing stamped metal plate halves, where each plate half includes embossed features, wherein each of the opposing plate halves are positioned in contact with each other in a manner so that the embossed features are offset relative to each other, and wherein the plurality of bipolar plates are subjected to a compressive force to provide a bead seal where the plate halves contact each other.

10. The fuel cell stack according to claim 9 wherein a seal path between the opposing plate halves are aligned, but a centerline of the seal path is offset.

11. The fuel cell stack according to claim 9 wherein the embossed features in the opposing plate halves define seals in the bipolar plate.

12. The fuel cell stack according to claim 9 wherein the bipolar plates extend across an active region and an inactive region in the fuel cell stack.

13. The fuel cell stack according to claim 9 wherein the embossed features are curved to accommodate an opening in the plate halves.

14. A method for assembling a fuel cell stack, said method comprising:
providing a first bipolar plate half including at least one embossed feature;
providing a second bipolar plate half including at least one embossed feature;
aligning the first and second bipolar plate halves together to define a bipolar plate so that the embossed features are offset relative to each other where a portion of contact areas in the first plate half extend across the embossed features in the second plate half and a portion of contact areas in the second plate half extend across the embossed features in the first plate half; and
applying pressure to the bipolar plate halves to seal the bipolar plates halves together and form bead seals.

15. The method according to claim 14 wherein aligning the first and second bipolar plate halves together includes aligning a seal path between the first and second plate halves so that a centerline of the seal path is offset.

16. The method according to claim 14 wherein providing a first bipolar plate and a second bipolar plate include providing stamped metal bipolar plate halves.

17. The method according to claim 14 wherein providing a first bipolar plate and a second bipolar plate include providing the embossed features to define seals.

18. The method according to claim 14 wherein the bipolar plate extends across an active region and an inactive region in the fuel cell stack.

19. The method according to claim 14 wherein the embossed features are curved to accommodate an opening in the first and second plate halves.

20. The method according to claim 14 further comprising providing a plurality of bipolar plates each including opposing first and second plate halves, wherein all of the first and second plate halves are subjected to a compressive force to provide a bead seal at the contact areas.
